(19) United States
(12) Patent Application Publication
(10) Pub. No.: US 2004/0199432 A1
(43) Pub. Date: Oct. 7, 2004

(54) Information processing system

(75) Inventors: Akinori Iwase, Yokosuka-shi (JP); Kazuhiro Ogura, Kawasaki-shi (JP); Tatsuya Haraguchi, Yokohama-shi (JP)

Correspondence Address: FOLEY AND LARDNER, SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/832,332

(22) Filed: Apr. 27, 2004

Related U.S. Application Data
(62) Division of application No. 09/845,522, filed on May 1, 2001, now abandoned.

(51) Int. Cl. G06F 17/60

(52) U.S. Cl. 705/26

(57) ABSTRACT

When a commodity has been purchased, display on a display section of a mobile phone is returned to a commodity purchase screen at a cash register, and “Total” is chosen and determined. When “Total” has been determined, a control section of the mobile phone causes the display section to display a totaling screen. The totaling screen displays a sum price of the purchased commodity, as well as choices of payment methods, “Cash” and “Credit card”, and choices of reception of the commodity, “Take out” and “Delivery”. The cash or credit card is chosen as a method of payment by the mobile phone, and whether the purchased commodity is to be taken out or delivered is chosen.

The present application is a divisional of U.S. application Ser. No. 09/845,522, filed May 1, 2001, the entire contents of which are incorporated herein by reference.

### BACKGROUND OF THE INVENTION

The present invention relates to an information processing system for providing any kind of information and carrying out an accounting process for commodities in shops, etc., using portable devices such as mobile phones.

In these years, portable devices such as mobile phones have widely prevailed among users. The mobile phone is used as a portable network terminal capable of easily accessing information at any place.

Information on commodities has conventionally been totaled or provided in shops.

For example, Jpn. Pat. Appln. KOKAI Publication No. 8-142871 discloses a technique for totaling, e.g. information on goods purchased within a shop. This publication shows a technique wherein a commodity is put in a shopping cart for dedicated use, a bar-code on the commodity that is indicative of information such as a preset price is read, and the information on commodities, the number of commodities, the sum of prices, etc. is sent to a center from a transmission section provided on the shopping cart, whereby the information is used for accounting by means of a cash-register.

Jpn. Pat. Appln. KOKAI Publication No. 9-282377 discloses a technique wherein when a commodity is to be bought in a shop, information on the commodity, etc. is provided at the place on a monitor by means of moving pictures, still images and voice.

In these techniques, dedicated systems are provided in shops, and they are used to total commodity information, etc. and to display and guide information.

In the techniques, although it is easy to total commodity information, etc. and to display and provide guidance information, it is not possible to total commodity information, etc. for individual customers and to display and provide guidance information for individual customers. For example, it is not possible to specifically recognize a case where a customer has a discount coupon, a case where a purchased commodity is to be delivered as a gift, or a method of use of purchased goods. Moreover, it is not possible to total commodity information, etc. and to display and provide guidance information in accordance with personal information and needs of the customer, and the information for advantageously using the purchased goods cannot easily be obtained.

### BRIEF SUMMARY OF THE INVENTION

An object of the present invention is to provide an information processing system capable of easily totaling and display-guiding commodity information, etc. in accordance with individual customers.

Another object of the invention is to provide an information processing system capable of providing commodity information to customers and easily providing information on the use of purchased commodities.

In order to achieve the objects, the invention provides an information processing system for processing information in a shop, the system comprising a portable device possessed by a user and a host computer for communication with the portable device, the portable device comprising: input means for inputting commodity information provided near a commodity or on the commodity, when the commodity in the shop is to be purchased; first memory means for storing the commodity information input by the input means; second memory means for prestoring user information; totaling means for totaling, when a price of one or more commodities based on one or more commodity information items stored in the first memory means is to be processed in the shop and if there is the user information in the second memory means, which corresponds to the commodity information stored in the first memory means, the commodity information stored in the first memory means by adding the user information corresponding to the commodity information; and transmission means for transmitting the total information totaled by the totaling means to the host computer.

The invention also provides an information processing system for processing information in a shop, the system comprising a portable device possessed by a user and a host computer for communication with the portable device, the host computer comprising: memory means for storing the number of inventories of each of commodities placed in the shop, and substitute commodity information corresponding to each commodity; first acquisition means for acquiring, when a commodity inventory inquiry request has been received from the portable device, the number of inventories of the associated commodity by searching the memory means; first transmission means for transmitting to the portable device the information on the number of inventories of the commodity acquired by the first acquisition means; second acquisition means for acquiring, when the number of the inventories of the commodity acquired by the first acquisition means is zero, substitute commodity information for the commodity by searching the memory means; and second transmission means for transmitting to the portable device the information to the effect that the number of the inventories of the commodity acquired by the first acquisition means is zero, and the substitute commodity information of the commodity acquired by the second acquisition means.

The invention provides an information processing system for processing information in a shop, the system comprising a portable device possessed by a user and a host computer for communication with the portable device, the portable device comprising: request means for requesting information on a predetermined finished article from the host computer in order to make the predetermined finished article; input means for inputting ingredient information put near an ingredient or on an ingredient placed within the shop, when necessary ingredients for making the finished article are purchased; and first memory means for storing the ingredient information input by the input means, and the host computer comprises: memory means for storing a plurality of finished article names and ingredient names of ingredients necessary for making the finished articles; first acquisition means for acquiring the name of an ingredient necessary for making the finished article by searching the second memory means, when a finished article information request is received from the portable device; second acquisition means for acquiring the ingredient information stored in the first memory means on the ingredient purchased to make the finished article; detection means for detecting the name of one or more deficient ingredients for making the finished article by comparing one or more ingredient names acquired from the ingredient information acquired by the second acquisition means and one or more ingredient names acquired by the first acquisition means; and transmission means for transmitting to the portable device the information on the one or more deficient ingredient names detected by the detection means.

The invention provides an information processing system for processing information in a shop, the system comprising a portable device possessed by a user and a host computer for communication with the portable device, the portable device comprising: request means for requesting information on a predetermined dish from the host computer in order to make the dish; input means for inputting ingredient information put near an ingredient or on an ingredient placed within the shop, when necessary ingredients for making the dish are purchased; and first memory means for storing the ingredient information input by the input means, and the host computer comprises: second memory means for storing a plurality of dish names and names of ingredients necessary for making each dish; first acquisition means for acquiring the name of an ingredient necessary for making the dish by searching the second memory means, when a dish information request is received from the portable device; second acquisition means for acquiring the ingredient information stored in the first memory means on the ingredient purchased to make the dish; detection means for detecting the name of one or more deficient ingredients for making the dish by comparing one or more ingredient names obtained from the ingredient information acquired by the second acquisition means and one or more ingredient names acquired by the first acquisition means; and transmission means for transmitting to the portable device the information on the one or more deficient ingredient names detected by the detection means.

The invention provides an information processing system for processing information in a shop, the system comprising a portable device possessed by a user and a host computer for communication with the portable device, the portable device comprising: input means for inputting commodity information provided near a commodity or on the commodity, when the commodity in the shop is to be purchased; memory means for storing the commodity information input by the input means; instruction means for instructing, where necessary, delivery of a commodity indicated in the commodity information stored in the memory means; designation means for designating a delivery destination of the commodity, the delivery of which has been instructed by the instruction means, from address information prestored in the portable device or address information prestored in the host computer; and transmission means for transmitting to the host computer one or more commodity information items stored in the memory means, instruction information instructed by the instruction means, and address information designated by the designation means.

The invention provides an information processing system for processing information in a shop, the system comprising a portable device possessed by a user and a host computer for communication with the portable device, the host computer comprising: memory means for prestoring intra-shop guidance information; search means for searching the memory means when an intra-shop guidance information request has been received from the portable device; and transmission means for transmitting to the portable device the intra-shop guidance information searched by the search means.

The invention provides an information processing system for processing information in a shop, the system comprising a portable device possessed by a user and a host computer for communication with the portable device, the host computer being connected to a network, the host computer comprising: search means for searching for information on a commodity sent from a company which provides the commodity via a network, when a request for information on the commodity in the shop has been received from the portable device; and transmission means for transmitting to the portable device the information on the commodity searched by the search means.

The invention provides an information processing system for processing information in a shop, the system comprising a portable device possessed by a user, a host computer for communication with the portable device, and a digital multi-functional peripheral that is variously settable and connected to the host computer, the portable device comprising: input means for inputting ingredient information put near an ingredient or on an ingredient placed within the shop, when necessary ingredients for making a dish are purchased; first memory means for storing the ingredient information input by the input means; and transmission means for transmitting to the host computer total information obtained by totaling the ingredient information stored in the first memory means, when an accounting process for the ingredients purchased in the shop is carried out, and the host computer comprises: second memory means for storing a plurality of dish names, names of ingredients necessary for making each dish, and a recipe of each dish; specifying means for searching the second memory means with one or more ingredient names obtainable from the total information, when total information on the ingredients purchased by the portable device is received, and specifying one or more dish names of a dish preparable from one or more ingredients; search means for searching for recipe information on one or more dishes stored in the memory means, on the basis of one or more dish names specified by the specifying means; and control means for performing a control to print out the recipe information on one or more dishes searched by the search means through the digital multi-functional peripheral.

### BRIEF DESCRIPTION OF THE SEVERAL VIEWS OF THE DRAWING

FIG. 1 is a block diagram schematically showing the structure of an information processing system according to the present invention;

FIG. 2 is a block diagram showing the whole structure of a mobile phone;

FIG. 3 is a block diagram showing the whole structure of a shop host;

FIG. 4 shows an example of the structure of a database;

FIG. 5 is a block diagram schematically showing the structure of a digital multi-functional peripheral;

FIG. 6 shows an example of personal information in a case where personal information is stored in a memory in a mobile phone;

FIG. 7 shows an example of the structure of a telephone directory;

FIG. 8 shows an example of the structure of a customer database;

FIG. 9 shows an example of the structure of a telephone directory database;

FIG. 10 shows an example of the structure of a customer-specific purchased commodity database;

FIG. 11 shows an example of the structure of an inventory table in an inventory database;

FIG. 12 shows an example of the structure of a recipe table in a recipe database;

FIG. 13 shows an example of the structure of an ingredient table in the recipe database;

FIG. 14 shows an example of the structure of a coupon database;

FIG. 15 shows an example of the structure of a delivery database;

FIG. 16 shows an example of the structure of a commodity information table in the inventory database;

FIG. 17 shows an example of the structure of a substitute commodity table in the inventory database;

FIG. 18 shows an example of the structure of a substitute ingredient table in the recipe database;

FIG. 19 shows an example of display on a display section of a mobile phone;

FIG. 20 shows an example of display on the display section of the mobile phone;

FIG. 21 shows an example of display on the display section of the mobile phone;

FIG. 22 shows an example of display on the display section of the mobile phone;

FIG. 23 shows an example of display on the display section of the mobile phone;

FIG. 24 shows an example of display on the display section of the mobile phone;

FIG. 25 shows an example of display on the display section of the mobile phone;

FIG. 26 shows an example of display on the display section of the mobile phone;

FIG. 27 shows an example of display on the display section of the mobile phone;

FIG. 28 shows an example of display on the display section of the mobile phone;

FIG. 29 shows an example of display on the display section of the mobile phone;

FIG. 30 shows an example of display on the display section of the mobile phone;

FIG. 31 shows an example of display on the display section of the mobile phone;

FIG. 32 shows an example of display on the display section of the mobile phone;

FIG. 33 shows an example of display on the display section of the mobile phone;

FIG. 34 shows an example of display on the display section of the mobile phone;

FIG. 35 shows an example of display on the display section of the mobile phone;

FIG. 36 shows an example of display on the display section of the mobile phone;

FIG. 37 shows an example of a printed-out receipt; and

FIG. 38 shows an example of a printed-out paella recipe.

### DETAILED DESCRIPTION OF THE INVENTION

Embodiments of the present invention will now be described with reference to the accompanying drawings.

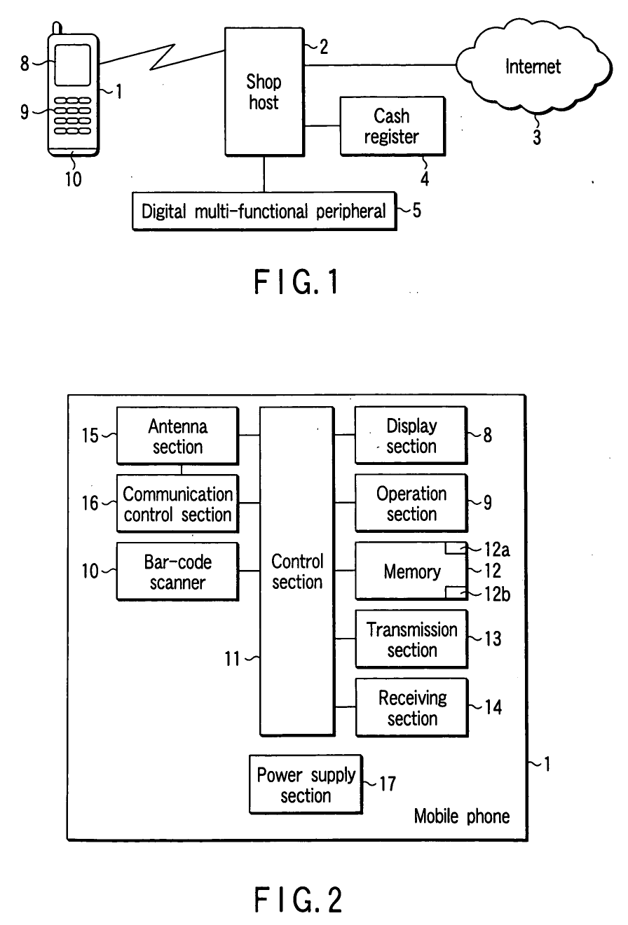

FIG. 1 schematically shows the structure of an information processing system according to the present invention. The information processing system comprises a mobile phone 1 serving as a portable device including a display section 8 and an operation section 9 with numeral keys; a shop host 2 for radio data transmission with the mobile phone 1; the Internet 3 to which the shop host 2 is connected; and a cash register 4 and a digital multi-functional peripheral 5 connected to the shop host 2.

The mobile phone 1 has a bar-code scanner 10 at its lower part, in addition to functions of an ordinary mobile phone.

The mobile phone 1 has a radio communication function for short-range information communication using Bluetooth. In addition, the mobile phone 11 has a function of an ordinary mobile phone for connection to a public line.

In addition, the mobile phone 1 has an ordinary call function by connection to a public line, and an IP connection function. The mobile phone 1 performs data exchange with the shop host 2 using the IP connection function. In a small shop or under a specified condition, data exchange using Bluetooth can be effected. Since the mobile phone 1 has the IP connection function, it can directly connect to the Internet 3. Alternatively, the mobile phone 1 can connect to the Internet 3 via the shop host 2. Moreover, the mobile phone 1 can connect to the Internet 3 by the IP connection function and perform packet communication on the Internet 3.

The shop host 2 is a server comprising a personal computer with a function of connection to the Internet. The shop host 2 manages various information and performs data exchange with the mobile phone 1.

The digital multi-functional peripheral 5 comprises a digital image forming apparatus and a digital image reading apparatus. The digital multi-functional peripheral (MFP) 5 includes a copying function, a printing function, a scanner function and a FAX function. The digital multi-functional peripheral is named after such multiple functions.

FIG. 2 shows the whole structure of the mobile phone 1. The mobile phone 1 comprises the display section 8, the operation section 9, the bar-code scanner 10, a control section 11, a memory 12, a transmission section 13, a receiving section 14, an antenna section 15, a communication control section 16 and a power supply section 17.

The display section 8 comprises a liquid crystal display device and displays various operation guidance. The operation section 9 comprises numeral keys and buttons for performing various operations. The operation section 9 effects input of numerals, such as telephone numbers, mode selection and various settings.

The bar-code scanner 10 scans a bar-code put on a commodity itself for identifying the commodity, when the commodity is purchased in a shop, as will be described later in greater detail. Alternatively, the bar-code scanner 10 may scan a bar-code put on a tag of a displayed commodity. Alternatively, the bar-code scanner 10 may scan a bar-code on a coupon, etc. Aside from the method of scanning bar-codes, the commodity can be identified by inputting a commodity code by depressing the numeral keys of the operation section 9 of the mobile phone 1.

The control circuit 11 controls the entirety of the mobile phone. The control circuit 11 comprises a CPU, etc. The memory 12 stores various information such as control programs, ID numbers (recognition numbers), etc. The transmission section 13 comprises a microphone, etc. The transmission section 13 converts voice produced by the user during the use of the mobile phone to voice data and outputs the voice data. The receiving section 14 comprises a loudspeaker, etc. The receiving section 14 reproduces the voice data supplied from some other device and outputs the reproduced result through the loudspeaker.

The communication control section 16 comprises a modulation/demodulation circuit (transmission/reception circuit) for connection to a public line. The antenna section 15 is connected to the communication control section 16. The communication control section 16 performs radio wave transmission/reception through the antenna section 15. When radio waves have been received by the antenna section 15, the received data is demodulated and supplied to the control circuit 11. When transmission data is to be transmitted from the control circuit 11, the communication control section 16 transmits the data from the antenna section 15 over radio waves. The communication control circuit 16 connects to the public line to perform a call control function and an IP connection function. The call control function is a function for controlling call communication with some other phone via the public line. The IP connection function is a function for controlling communication when data transmission/reception is performed over the Internet via the public line.

The power supply section 17 supplies power supply voltage to the display section 8, operation section 9, bar-code scanner 10, control circuit 11, memory 12, transmission section 13, receiving section 14 and communication control circuit 16.

The same operations as described below can also be performed when a device other than the mobile phone is used as the portable device.

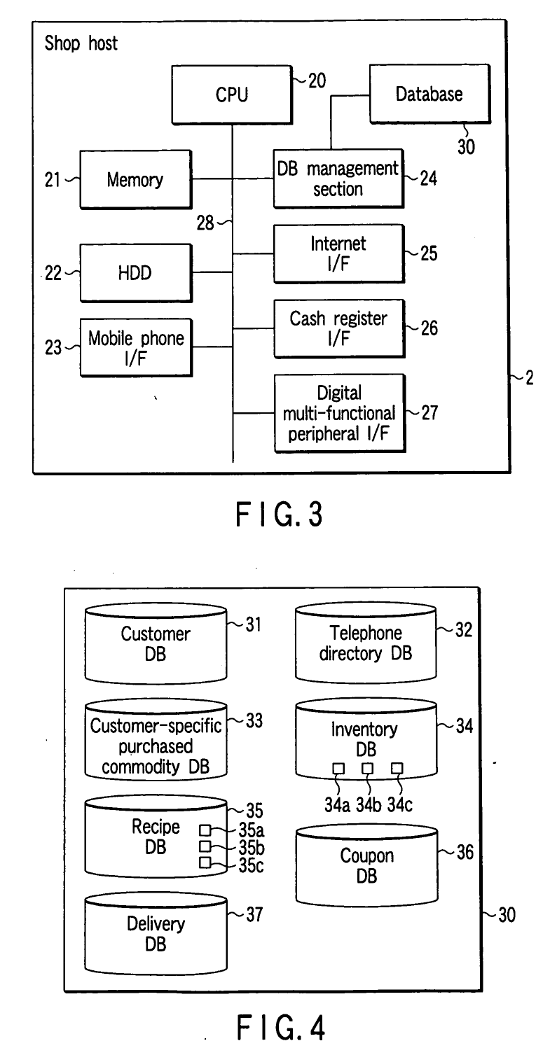

FIG. 3 shows the whole structure of the shop host 2. Specifically, the shop host 2 comprises a CPU 20, a memory 21, a hard disk drive (HDD) 22, a mobile phone interface (I/F) 23, a database (DB) management section 24, an Internet interface (I/F) 25, a cash register interface (I/F) 26, and a digital multi-functional peripheral interface (I/F) 27. These structural elements are connected over a bus 28. Necessary data is transmitted/received among the structural elements over the bus 28. The DB management section 24 manages a database 30, as will be described later in detail.

The CPU 20 controls all operations of the shop host 2. The CPU 20 operates according to control programs, control data, etc. prestored in the memory 21.

The memory 21 comprises a ROM storing control programs, control data, etc., an NVM storing variable set values, and a RAM temporarily storing information. When the CPU 20 is operated, the memory 21 is used to temporarily store various information and to temporarily store part of data.

The HDD 22 stores various data. The HDD 22 stores various data for operating the shop host 2, user-specific set information, etc.

The mobile phone I/F 23 functions for data exchange with the mobile phone 1.

The DB management section 24 manages various databases. These databases are stored in hard disks, optical disks, magneto-optical disks, etc.

The Internet I/F 25 is an interface for connection to the Internet 3. Data transmission/reception with the Internet 3 is effected via this interface.

The cash register I/F 26 is an interface for connection to the cash register 4. Data transmission/reception with the cash register 4 is effected via this interface.

The digital multi-functional peripheral I/F 27 is an interface for connection to the digital multi-functional peripheral 5. Data transmission/reception with the digital multi-functional peripheral 5 is effected via this interface.

As will be described later in detail, the above information processing system can provide the following services when a commodity is purchased in a shop using the mobile phone 1.

1. Information of a specified commodity can be displayed on the display section 8. The information may be prepared by the shop, or displayed from a Web page of the company of the commodity via the Internet.

2. Purchased commodities can be successively totaled by scanning bar-codes of the commodities by means of the bar-code scanner 10 of mobile phone 1, or registering the commodities.

3. A commodity can be introduced by using a customer's personal information such as coupon information and profile information.

4. Information on bargain items, etc. of the shop can be provided.

5. A recipe available with purchased food can be provided. In addition, a deficient article of food for a pre-selected recipe can be indicated.

6. A gift can be delivered using address information possessed by the mobile phone 1 or the shop host 2.

7. A purchasing procedure can be carried out only by scanning and inputting the bar-code put on a commodity by means of the scanner 10 of mobile phone 1, without pushing a shopping cart in a shop.

8. When an accounting procedure for the commodity (or commodity information) purchased using the mobile phone 1 is carried out by the cash register 4 in the shop, a recipe, etc. can be printed out along with a receipt and handed to the customer.

FIG. 4 shows an example of the structure of the database 30. The database 30 comprises a customer database (DB) 31, a telephone directory database (DB) 32, a customer-specific purchased commodity database (DB) 33, an inventory database (DB) 34, a recipe database (DB) 35, a coupon database (DB) 36 and a delivery database (DB) 37. This structure of the database 30 is only an example, and more databases may be provided. Alternatively, some of these databases may be integrated to reduce the number of databases.

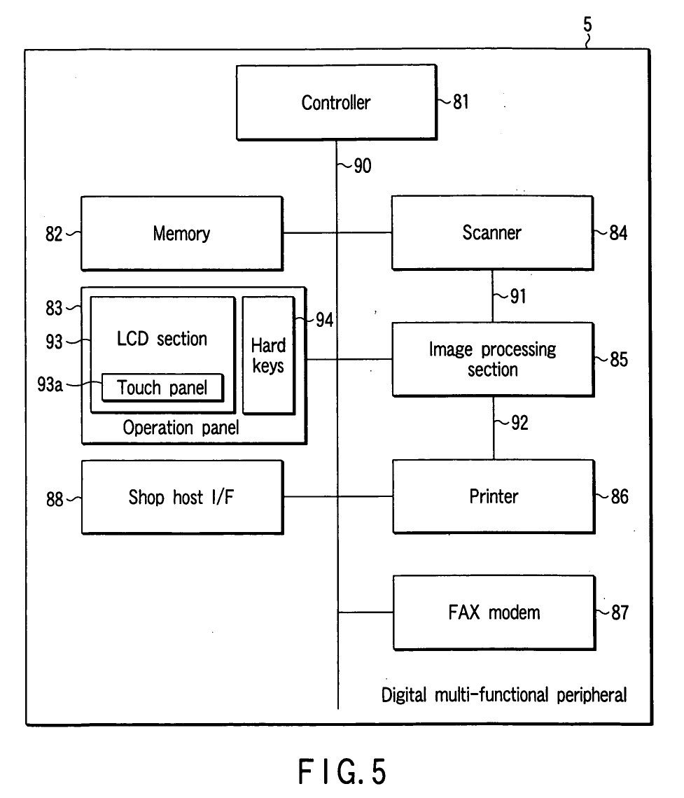

FIG. 5 schematically shows the structure of the digital multi-functional peripheral 5. The digital multi-functional peripheral 5 comprises a controller 81, a memory 82, an operation panel 83, a scanner 84, an image processing section 85, a printer 86, a FAX modem 87 and a shop host interface (I/F) 88.

The structural elements 81 to 88 are connected over a bus 90. Necessary data is transmitted/received among the structural elements over the bus 90. The scanner 84 and image processing section 85 are connected over an image data bus 91. Thereby, image data read by the scanner 84 is sent at high speed to the image processing section 85 over the image data bus 91. The image processing section 85 and the printer 86 are connected over an image data bus 92. The image data processed by the image processing section 85 is sent at high speed to the printer 86 over the image data bus 92.

The controller 81 controls the operation of the entirety of the digital multi-functional peripheral. The controller 81 comprises a CPU (Central Processing Unit), etc. The controller 81 operates according to prestored control programs and control data.

The memory 82 comprises a ROM storing control programs, control data, etc., an NVM storing variable set values, and a RAM temporarily storing information. When the controller 81 is operated, the memory 82 is used to temporarily store various information and to temporarily store part of data.

The operation panel 83 comprises a display section 93 and hard keys 94. The display section 93 comprises a liquid crystal display (LCD) including a touch panel 93a. The display section 93 displays the operational condition of the digital multi-functional peripheral, operation guidance information for users, etc. The touch panel 93a of display section 93 displays touch keys for accepting a user's operation. The hard keys 94 include numeral keys and a copying operation start key.

The scanner 84 reads an original. The scanner 84 optically scans the original and converts the image on the original to image data. The image processing section 85 processes image data. The image processing section 85 subjects image data to various processes. The printer 86 print out the image data on a paper sheet. The printer 86 may adopt various printing methods such as an electrophotographic method and an ink-jet method. In this embodiment, the printer 86 uses the electrophotographic method.

The FAX modem 87 connects to the public line to perform data transmission/reception processing with an external device. The FAX modem 87 has a facsimile function and an Internet connection function. With the facsimile function, image data read by the scanner 84 is sent as facsimile data via the public line, and FAX data is received from an external device and printed out on a paper sheet by means of the printer 86. With the Internet connection function, connection to the Internet is effected via the public line, and data transmission/reception is effected with the external device over the Internet.

The shop host I/F 88 is an interface for connection to the shop host 2. Data transmission/reception with the shop host 2 is effected via this interface.

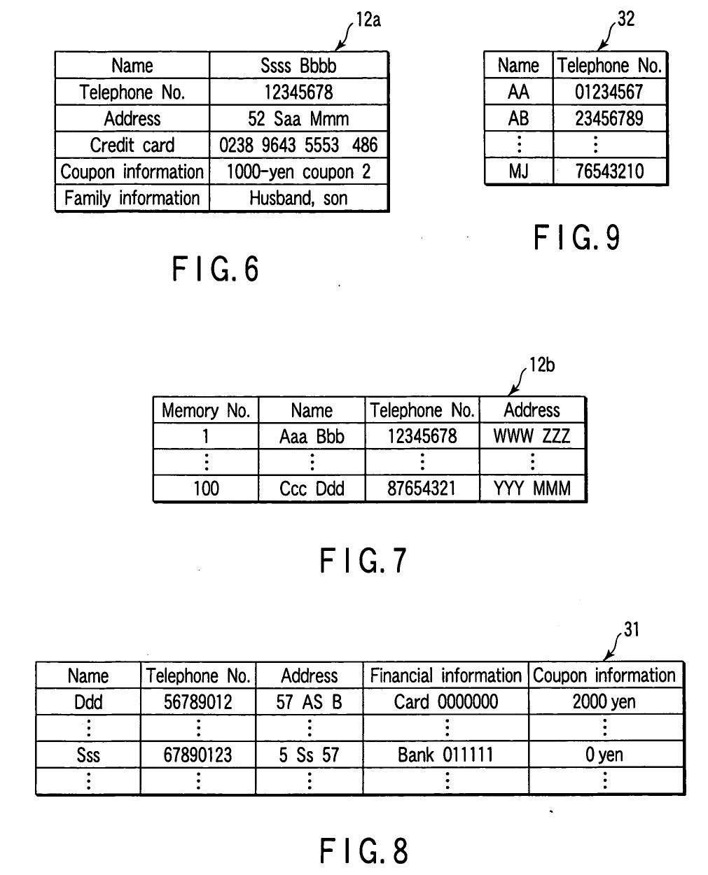

FIG. 6 shows an example of personal information in a case where personal information 12a is stored in the memory 12 of mobile phone 1. In this example, the personal information comprises a name, a telephone number of the mobile phone, an address, a credit card number as financial transaction information, coupon information as a benefit of the user, and family information. Using the customer information and family information (preference of the family), information on a suitable item as a substitute commodity can be provided.

Depending on the type of mobile phone 1, the memory 12 of mobile phone 1 does not store the personal telephone directory 12b. The memory 12 of mobile phone 1 stores a personal telephone directory 12b.

FIG. 7 shows an example of the personal telephone directory. In this example, the personal telephone directory stores a memory number, a name, a telephone number and an address. Depending on the type of the mobile phone 1, the address may not be stored, or plural telephone numbers for a memory number or a name may be stored. For instance, in association with memory number “1”, name “Aaa Bbb”, telephone number “12345678” and address “WWW ZZZ” are stored.

Each database constituting the database 30 will now be described.

FIG. 8 shows an example of the structure of the customer DB 31. The customer DB 31 stores a name, a telephone number, an address, financial information and coupon information. The customer DB 31 is used like the personal information in the mobile phone 1 as shown in FIG. 6. If the address, financial information and coupon information are not stored, depending on the type of the mobile phone 1, the information in the customer DB 31 is used. For example, in association with the name “Ddd”, telephone number “56789012”, address “57ASB”, financial information “card 0000000” and coupon information “2000 yen” are stored.

If there is a discrepancy between the information stored in the memory 12 of mobile phone 1 and the information stored in the customer DB 31, the information stored in the memory 12 of mobile phone 1 may be preferentially used since the customer is carrying this information.

FIG. 9 shows an example of the structure of the telephone directory DB 32. In this example, the telephone directory DB 32 comprises a name and a telephone number. Additionally, an address may be stored in the telephone directory DB 32. The telephone directory DB 32 is produced based on the telephone directories of the whole country. For example, telephone number “01234567” is stored in association with the name “AA”.

FIG. 10 shows an example of the structure of the customer-specific purchased commodity DB 33. A customer-specific table is prepared in the customer-specific purchased commodity DB 33. For example, if ten customers are shopping, ten tables are produced. The table is prepared at the beginning of shopping, and it is erased after accounting is finished at the cash register 4. In addition, a commodity purchase record is stored in another table in the customer-specific purchased commodity DB 33. In this way, a purchase history is left. The customer-specific table prepared in the customer-specific purchased commodity DB 33 comprises a commodity code, the number of commodities, and price. Each time a customer has purchased one commodity, one record is increased. For example, the number of commodities “1” and the price “100” are produced in association with commodity code “A1234567890” of the purchased commodity.

FIG. 11 shows an example of the structure of the inventory table 34a of the inventory DB 34. The inventory table 34a manages the inventory of the commodities treated in the shop. The inventory 34a comprises a commodity code, the number of inventories, bargain item distinction, retail price and possible next arrival of goods. The number of inventories is decreased as a customer has purchased the commodity. The “bargain item distinction” indicates distinction between a time-limited sale item, a term-limited sale item, etc. For example, in association with commodity code “AA5326327”, the number of inventories “100”, the bargain item distinction “A”, the retain price “55” and the possible next arrival of goods “Oct. 9, 2000” are produced.

FIGS. 12 and 13 show examples of the structure of the recipe DB 35. FIG. 12 shows a recipe table 35a indicating the kind of recipe in the recipe DB 35. The recipe table 35a of recipe DB 35 comprises a dish name and a recipe file name. A file associated with the recipe file name shows details of a recipe. If the content of the file is printed out, the procedure of cooking is understood. For example, when the dish name is “Paella”, the recipe file name is “File 001.doc” and the details of the recipe of this dish is stored in this file.

In addition, the recipe DB 35 has an ingredient table 35b shown in FIG. 13. The ingredients of dishes are stored in the ingredient table 35b shown in FIG. 13. The ingredient table 35b comprises a dish name and ingredients. For example, the ingredients of the dish name “Paella” are “rice”, “opinion”, “garlic” and “red bell pepper.”

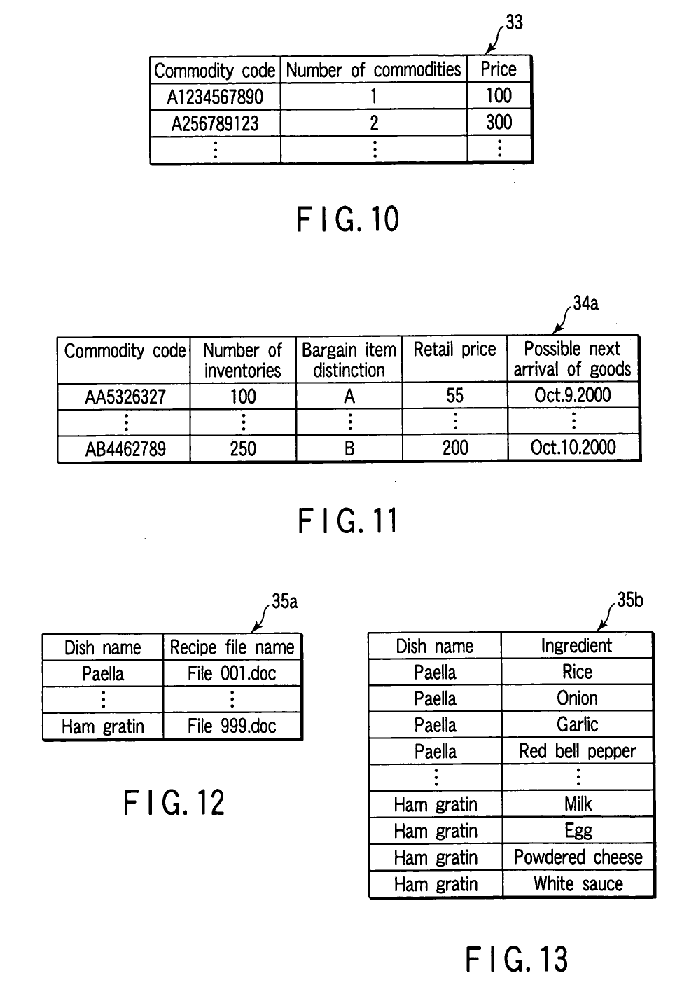

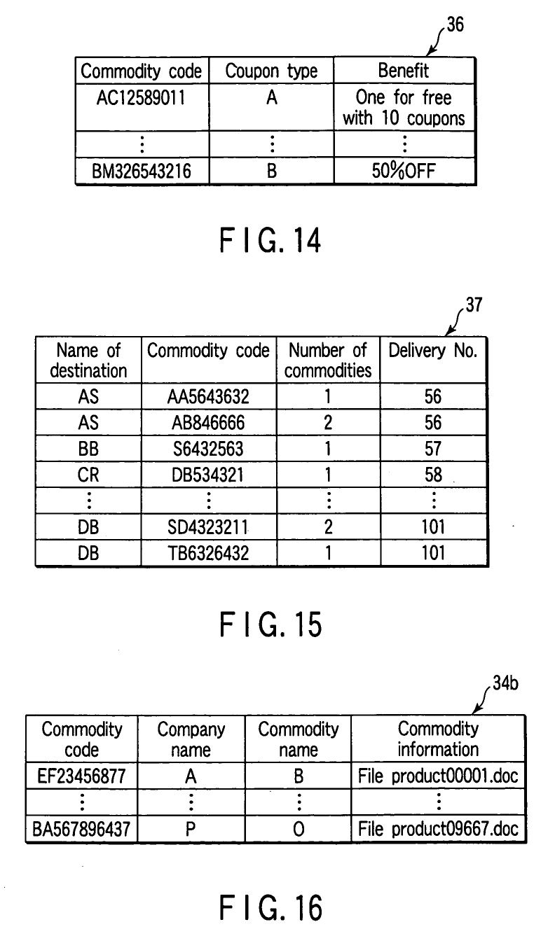

FIG. 14 shows an example of the structure of the coupon DB 36. The coupon DB 36 comprises a commodity code, a coupon type and a benefit. The coupon type indicates the type of coupon. The benefit indicates a benefit obtained by the coupon. For example, when the commodity code is “AC1258901”, the coupon “A” is stored and the benefit “one for free with 10 coupons” is obtained.

FIG. 15 shows an example of the structure of the delivery DB 37. The delivery DB 37 is not used when a customer purchases a commodity and takes it home. This is used when a customer purchases a commodity and asks for delivery. The delivery DB 37 comprises a name of destination, a commodity code, the number of commodities and a delivery number. In this example of the delivery DB 37, commodities with the same delivery number are sent by the same delivery. For example, in association with the name of destination “AS”, the following information is stored: the commodity code “AA5643632”, the number of commodities “1”, and the delivery No. “56”.

FIG. 16 shows an example of the structure of the commodity information table 34b in the inventory DB 34. The commodity information table 34b comprises a commodity code, a company name, a commodity name and commodity information. A file name is stored as “commodity information.” This file contains guidance information on the commodity. For example, in association with the commodity code “EF23456877”, the following information is stored: the company name “A”, the commodity name “B” and the commodity information “File product 00001.doc.”

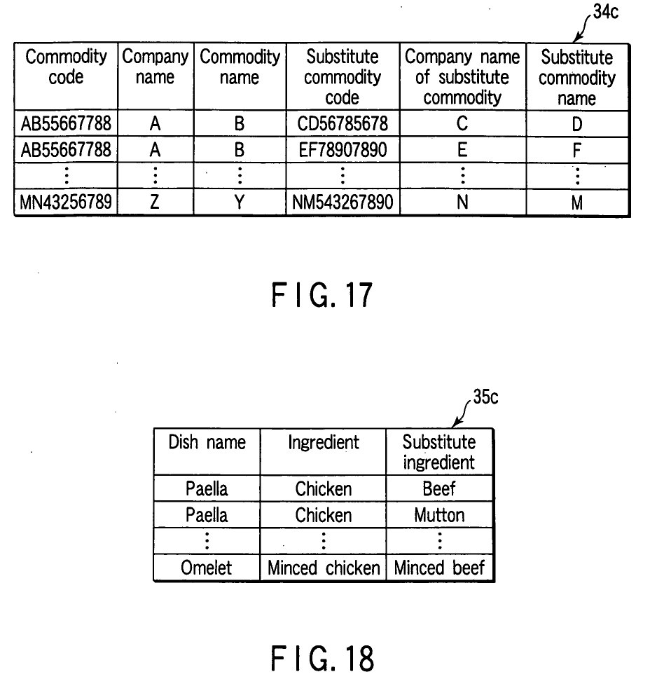

FIG. 17 shows an example of the structure of the substitute commodity table 34c in the inventory DB 34. The substitute commodity table 34c is used for providing a customer with information on an equivalent commodity when a commodity (desired commodity) to be purchased by the customer is out of stock. The substitute commodity table 34c comprises a commodity code, a company name, a commodity name, a substitute commodity code, a company name of a substitute commodity, and a substitute commodity name. Thereby, a customer, who asks for an out-of-stock commodity, may be provided with information on a substitute commodity. In the substitute commodity table 34c, for example, in association with the commodity code “AB55667788” of a commodity to be purchased, the following information is stored: the company name “A”, commodity name “B”, substitute commodity code “CD56785678”, substitute commodity company name “C”, and substitute commodity name “D”.

FIG. 18 shows an example of the structure of the substitute ingredient table 35c in the recipe DB 35. The substitute ingredient table 35c is used to provide a customer, who asks for an out-of-stock ingredient of a dish of a recipe, with information on other substitute ones. Thus, the substitute commodity table 35c comprises a dish name, an ingredient and a substitute ingredient. For example, information on substitute ingredient “Beef” or “Mutton” may be provided for the ingredient “Chicken” of the dish name “Paella.”

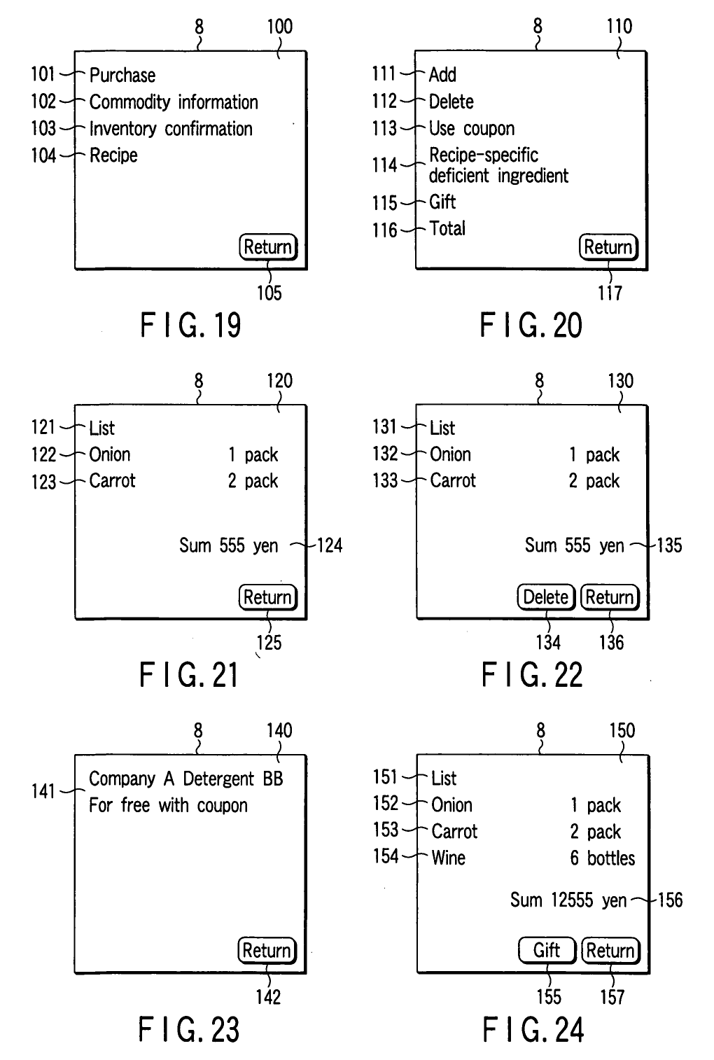

The operation of the information processing system having the above structure will now be described referring to examples of display on the display section 8 of mobile phone 1 as shown in FIGS. 19 to 33. As mentioned above, when a commodity is purchased in a shop using the bar-code scanner 10 of the mobile phone 1, a bar-code put on the commodity is scanned to identify the commodity.

In this case, two methods are available.

In a first method, a customer puts commodities in a cart, while pushing it. At the same, the customer operates the mobile phone 1 to obtain information of the purchased commodities.

In a second method, a customer without a cart carries the mobile phone 1 alone, and inputs commodity information of purchased commodities through the mobile phone 1. The customer does not pick up real commodities and receives them at the cash register 4. Alternatively, the customer asks for delivery of them.

Either method can be adopted in the information processing system of the present invention. The second method, by way of example, will now be described, wherein the customer without a cart inputs commodity information of purchased items.

Assume that a shop constitutes the information processing system of the present invention.

A customer enters the shop and operates the operation section 9 of mobile phone 1.

FIG. 19 shows a menu screen 100, as an example of display, on the display section 8 of mobile phone 1. The menu screen 100 is displayed by operating the operation section 9 of mobile phone 1, as mentioned above. The menu screen 100 displays four choice items and a “Return” box. Specifically, it displays “Purchase” 101, “Commodity information” 102, “Inventory confirmation” 103, “Recipe” 104, and “Return” box 105.

To begin with, an operation will be described, when the “Purchase” 101 has been chosen on the menu screen 100.

If the “Purchase” 101 has been chosen on the menu screen 100 by the operation of the operation section 9 of mobile phone 1, the control section 11 enters the connection mode for connection with the shop host 2. In the connection mode with the shop host 2, the display section 8 displays a commodity purchase screen 110 as shown in FIG. 20. Thereby, a commodity can be purchased in the shop.

The commodity purchase screen 110 displays “Add” 111, “Delete” 112, “Use coupon” 113, “Recipe-specific deficient ingredient” 114, “Gift” 115, “Total” 116, and “Return” box 117.

Assume that the customer has scanned the bar-code put on a commodity by means of the bar-code scanner 10 of mobile phone 1. For example, two packs of “carrot” has been scanned.

If “Add” 111 is chosen on the commodity purchase screen 110 on mobile phone 1, the scanned, newly purchased commodity is added, and the display section 8 displays a list screen 120 as shown in FIG. 21. The list screen 120 displays “List” 121, “Opinion 1 pack” 122, “Carrot 2 packs” 123, “Sum 555 yen” 124, i.e. the total amount, and “Return” box 125. In this way, the commodity (“Carrot 2 packs” 123) added to the list 121 is displayed.

When “Delete” 112 has been chosen on the commodity purchase screen 110, the display section 8 displays a delete screen 130 as shown in FIG. 22. If a commodity to be deleted is chosen and determined and “Delete” box 134 is chosen, the control section 11 deletes the chosen commodity from the list. For example, when “Opinion 1 pack” 132 is chosen and “Delete” box 134 is chosen, the control section 11 deletes “Opinion 1 pack” 132 and recalculates “Sum” 135.

When “Use coupon” 113 is chosen on the commodity purchase screen 110, a coupon screen 140 as shown in FIG. 23 is displayed. For example, “Company A Detergent BB For free with coupon” 141 has been chosen on the coupon screen 140, the control section 11 sets the price of the detergent BB of Company A at zero and recalculates the sum.

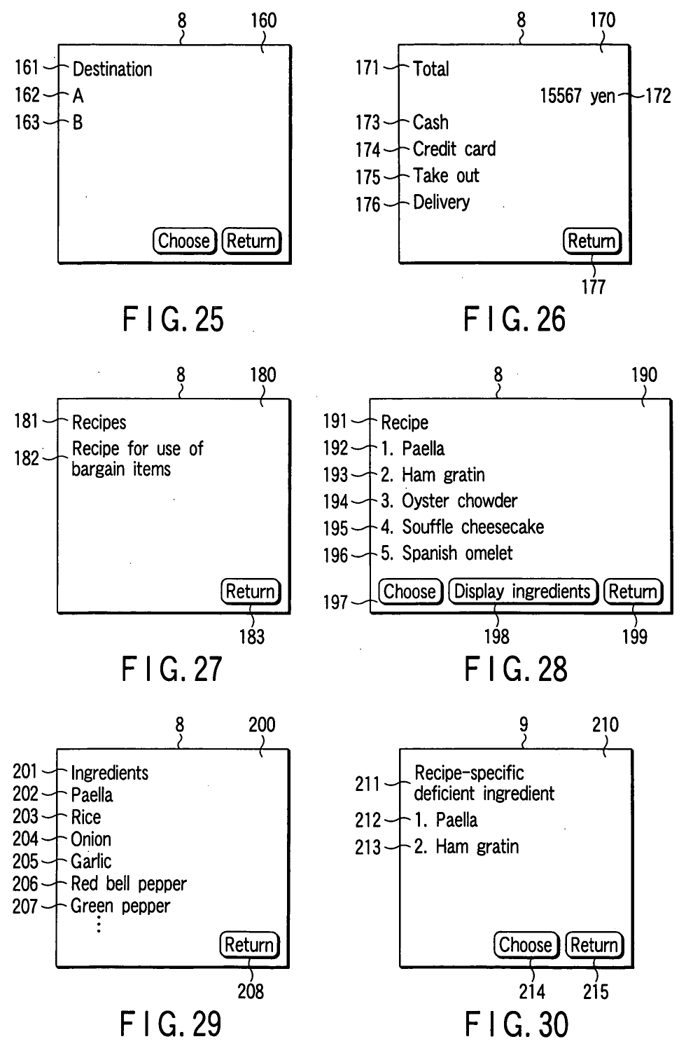

When “Gift” 115 is chosen and determined on the commodity purchase screen 110, the display section 8 displays a gift screen 150 as shown in FIG. 24. The gift screen 150 displays “List” 151, “Opinion 1 pack” 152, i.e. purchased commodity, “Carrot 2 packs” 153, “Wine 6 bottles” 154, the sum “Sum 12555 yen” 156, “Gift” box 155, and “Return” box 157. If “Wine 6 bottles” 154 is chosen and determined and “Gift” box 155 is chosen on the gift screen 150, the control section 11 displays a delivery destination screen 160 as shown in FIG. 25. In this case, destinations registered on the personal telephone directory stored in the memory 12 of mobile phone 1, as shown in FIG. 7, are displayed.

If the destination is chosen and determined and “Choose” box 164 is chosen on the delivery destination screen 160, the control section 11 adds the delivery destination data to the data “Wine 6 bottles” 154. If address information is not present on the personal telephone directory stored in the memory 12 of mobile phone 1, the address information is acquired by searching the telephone directory DB 32 in the shop host 2 that is shown in FIG. 9.

If the commodities have thus been purchased, the screen on the display section 8 of mobile phone 1 is restored to the commodity purchase screen 110 shown in FIG. 20 at the cash register 4 and the “Total” 116 is chosen and determined. If “Total” 116 is determined, the control section 11 enables the display section 8 to display a totaling screen 170 as shown in FIG. 26. The totaling screen 170 displays the screen name of “Total” 171, the sum of the purchased commodities “15567 yen” 172, choices of payment methods “Cash” 173 and “Credit card” 174, choices of reception of commodities “Take out” 175 and “Delivery” 176, and “Return” box 177.

In this way, the total amount of all purchased commodities is displayed. Then, the method of payment, “Cash” or “Credit card”, is chosen, and the method of reception of purchased commodities, “Take out” or “Delivery”, is also chosen.

A description will now be given of the operation in a case where “Recipe” 104 has been chosen on the menu screen 100.

If the “Recipe” 104 is chosen by the operation of the operation section 9 on the menu screen 100, the control section 11 enters the connection mode for connection with the shop host 2. In the connection mode with the shop host 2, the display section 8 displays a recipe screen 180 as shown in FIG. 27. Recipes of dishes are displayed. The recipe screen 180 displays two items: “Recipes” 181, which are all recipes, and “Recipe for use of bargain items” 182, which recipes for dishes to be cooked using bargain commodities.

When “Recipes” 181 is chosen and determined on the recipe screen 180, the control section 11 acquires information of dish names from the recipe table 35a in the recipe DB 35 of the shop host 2, and enables the display section 8 to display a recipe screen 180 shown in FIG. 28. If the recipes (dish names) cannot be contained within the screen of the display section 8, they may be displayed by using a scroll function. The recipe screen 190 displays the screen name “Recipe” 191, and dish names “1. Paella” 192, “Ham gratin” 193, “Oyster chowder” 194, “Soufflé cheesecake” 195 and “Spanish omelet” 196, as well as “Choose” box 197, “Display ingredients” box 198 and “Return” box 199.

When a dish name is chosen and determined and “Choose” box 197 is chosen on the recipe screen 190, the control section 11 registers this dish name in the memory 12.

When a dish name (e.g. paella) is chosen and determined and “Display ingredients” box 198 is chosen on the recipe screen 190, the control section 11 acquires ingredient information of the dish name (paella) from the recipe table 35b in the recipe DB 35 of shop host 2, and enables the display section 8 to display an ingredient screen 200 as shown in FIG. 29. In this example, the ingredient screen 200 displays the screen name “Ingredients” 201, the dish name “Paella” 202, and ingredients “Rice” 203, “Onion” 204, “Garlic” 205, “Red bell pepper” 206 and “Green pepper” 207, as well as “Return” box 208.

If the screen is returned to the commodity purchase screen 110 shown in FIG. 20 and “Recipe-specific deficient ingredient” 114 is chosen, the control section 11 enables the display section 8 to display a recipe-specific deficient ingredient screen 210 as shown in FIG. 30. The recipe-specific deficient ingredient screen 210 displays the dish names registered in the memory 12 by the customer.

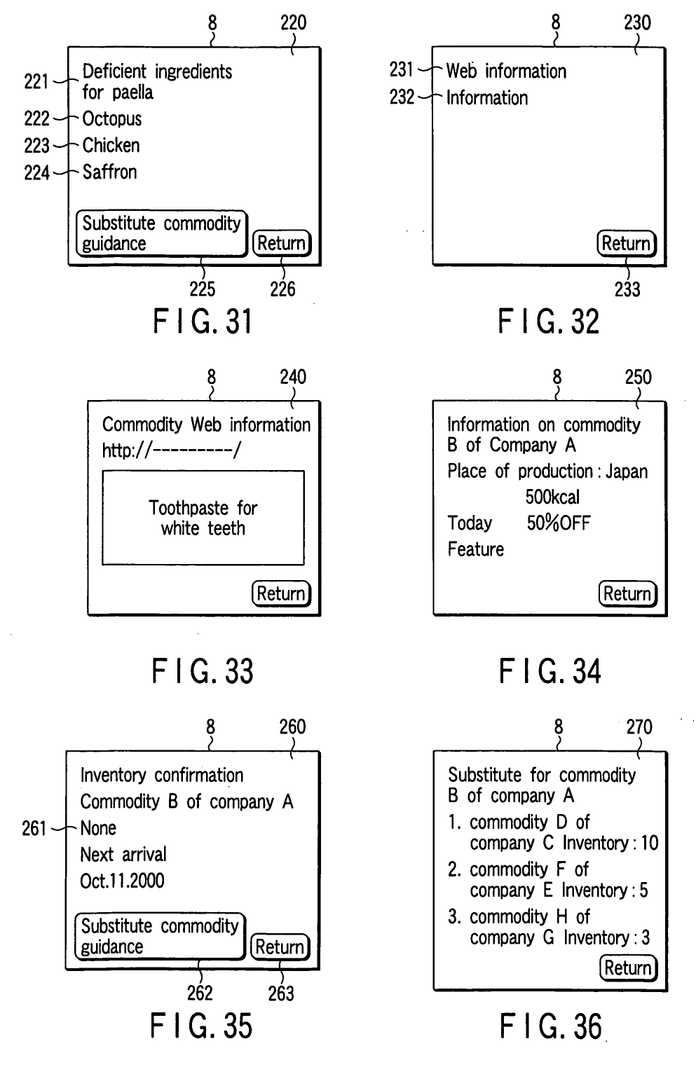

For example, when “1. Paella” is chosen and determined and “Choose” box 204 is chosen on the recipe-specific deficient ingredient screen 210, the control section 11 enables the display section 8 to display a deficient-ingredient-for-paella screen 220 as shown in FIG. 31. The deficient-ingredient-for-paella screen 220 displays the screen name “Deficient ingredients for paella” 221 and deficient ingredients “Octopus” 222, “Chicken” 223, “Saffron” 224, as well as “Substitute commodity guidance” box 225 and “Return” box 226. This screen displays a check result obtained by the control section 11, which has checked non-purchased ingredients for paella.

If any of the displayed ingredients is out of stock in the shop, that ingredient is chosen and determined and “Substitute commodity guidance” box 225 is chosen, the control section 11 provides information on the substitute commodity. Specifically, the control section 11 acquires, from the recipe table 35c in the recipe DB 35 of shop host 2, substitute commodity information for the deficient ingredient for the dish (e.g. paella), and displays the acquired information on the display section 8. Thereby, information on ingredients of a dish, including information on deficient ingredients, can be provided.

A description will now be given of an operation in a case where the “Commodity information” 102 has been chosen on the menu screen 100.

When the “Commodity information” 102 is chosen on the menu screen 100 by the operation of the operation section 9, the control section 11 enters a connection mode for connection with the shop host 2. In the connection mode with the shop host 2, the display section 8 shows a Web information screen 230 shown in FIG. 32. The Web information screen 230 displays “Web information” 231, “Information” 232 and “Return” box 233.

For example, when “Web information” 231 has been chosen on the Web information screen 230 by the operation of the operation section 9, the control section 11 acquires information on the Web page via the shop host 2 and the Internet 3, and displays the acquired information on the display section 8. FIG. 33 shows, as an example of display, a commodity Web information screen 240.

Alternatively, when “Information” 232 has been chosen on the Web information screen 230 by the operation of the operation section 9, the control section 11 acquires shop information from the shop host 2 and displays it on the display section 8. FIG. 34 shows a shop information screen 250, which is displayed on the display section 8. The shop information screen 250 shows, for example, information on commodity B of Company A. This shop information is prepared in advance on the shop side every day or every week and stored in the memory 21. Upon a shop information request, the CPU 20 reads out the information and transmits it.

An operation in a case where the “Inventory confirmation” 103 has been chosen on the menu screen 100 will now be described.

When the “Inventory confirmation” 103 is chosen on the menu screen 100 by the operation of the operation section 9, the control section 11 enters a connection mode for connection with the shop host 2. Then, if a commodity (e.g. commodity B of Company A) for inventory confirmation is input by the operation of the operation section 9, the control section 11 enables the display section 8 to display an inventory confirmation screen 260 as shown in FIG. 35. The inventory confirmation screen 260 displays an inventory condition, a next arrival date, etc. The information on the inventory confirmation screen 260 is acquired by the control section 11, which searches the inventory table 34a of inventory DB 34 of shop host 2 using a commodity code of the commodity.

The inventory confirmation screen 260 shown in FIG. 35 displays “Inventory confirmation, Commodity B of company A, None (inventory), Next arrival, Oct. 11, 2000” 261, as well as “Substitute commodity guidance” box 262 and “Return” box 263.

When the “Substitute commodity guidance” 262 has been chosen on the inventory confirmation screen 260 by the operation of the operation section 9, the control section 11 acquires substitute commodity information by searching the inventory table 34c of inventory DB 34 of shop host 2, and displays the acquired information on the display section 8. FIG. 36 shows a “Substitute for commodity B of company A” screen 270 by way of example. The “Substitute for commodity B of company A” screen 270 displays, as substitutes for commodity B of company A, “1. commodity D of company C Inventory: 10”, “2. commodity F of company E Inventory: 5” and “3. commodity H of company G Inventory: 3.” Thereby, substitute commodities may be purchased.

Assume that the shopping is finished and the “Total” 116 is chosen on the commodity purchase screen 110 on mobile phone 1, as shown in FIG. 20, at the cash register 4 for settling payment for purchased commodities. In this case, the control section 11 transmits a totaling request to the shop host 2.

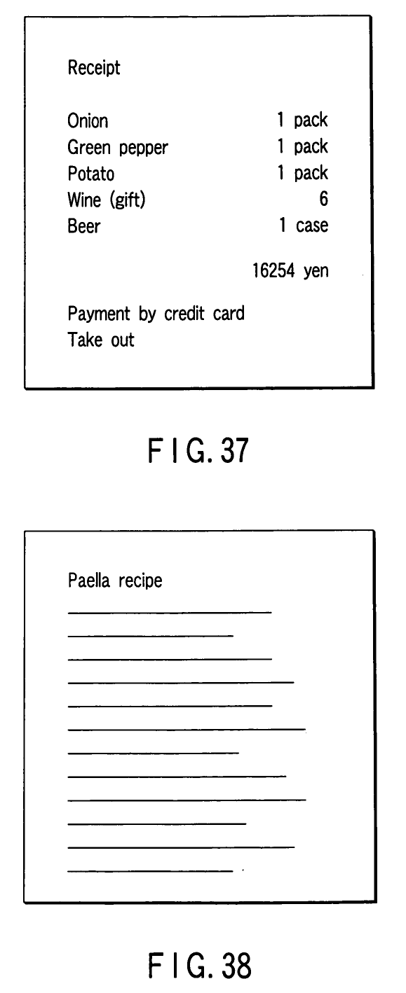

Responding to the totaling request received from the mobile phone 1 via the mobile phone I/F 23, the CPU 20 of the shop host 2 shop host 2 acquires receipt information based on the customer table in the customer-specific purchased commodity DB 33 and sends it to the cash register 4 via the cash register I/F 26. The cash register 4 prints out a receipt as shown in FIG. 37.

The CPU 20 reads out associated information from the database 30 via the DB management section 24 in response to request information contained in the totaling request from the mobile phone 1. The CPU 20 sends the read-out information to the digital multi-functional peripheral 5 via the digital multi-functional peripheral I/F 27. The digital multi-functional peripheral 5 prints out the information.

For example, when the request information is a paella recipe request, the CPU 20 searches the recipe table 35a of recipe DB 35 for the paella recipe file name, reads out the paella recipe file information, and transmits this information to the digital multi-functional peripheral 5. Based on the transmitted paella recipe file information, the digital multi-functional peripheral 5 prints out a paella recipe as shown in FIG. 38.

Alternatively, referring to the ingredient table 35b of recipe DB 35, the CPU 20 of shop host 2 may specify the name of a dish that can be made of the ingredients purchased by the customer. The CPU 20 then reads out the recipe file information of the dish name from the recipe table 35a of recipe DB 35, and prints out a recipe through the digital multi-functional peripheral 5.

According to the above-described embodiment of the present invention, information services in shops, etc. can be provided for easily providing information to customers and easily carrying out totaling.

With use of a mobile phone capable of IP connection, information of a commodity can be obtained by accessing a company producing such a commodity.

Using customer information and family information (preference of the family), information on a suitable item as a substitute commodity can be provided.

As regards food commodities, advice (deficient commodity, substitute commodity, bargain commodity, etc.) on purchase can be provided in association with individual recipes.

What is claimed is:

1. An information processing system for processing information in a shop, the system comprising a portable device possessed by a user and a host computer for communication with the portable device, the host computer being connected to a network, the host computer comprising:
search means for searching for information on a commodity sent from a company which provides the commodity via a network, when a request for information on the commodity in the shop has been received from the portable device; and
transmission means for transmitting to the portable device the information on the commodity searched by the search means.

2. An information processing system according to claim 1, wherein said network is the Internet.

3. An information processing system according to claim 1, wherein said search means searches a home page of a web server of a company that provides the commodity.
